(19) United States
(12) Patent Application Publication
(10) Pub. No.: US 2023/0132437 A1
(43) Pub. Date: May 4, 2023

(54) METHOD AND APPARATUS FOR SHARING CHANNEL OCCUPANCY TIME

(71) Applicant: Lenovo (Beijing) Ltd., Beijing (CN)

(72) Inventors: Haipeng Lei, Haidian District (CN); Xiaodong Yu, HAIDIAN DISTRICT (CN); Zhennian Sun, CHAOYANG DISTRICT (CN); Xin Guo, CHAOYANG DISTRICT (CN)

(73) Assignee: Lenovo (Beijing) Ltd., Beijing (CN)

(21) Appl. No.: 17/918,445

(22) PCT Filed: Apr. 22, 2020
(86) PCT No.: PCT/CN2020/086055

§ 371 Date: Oct. 12, 2022

(51) Int. Cl. H04W 74/08; H04W 74/00

(52) U.S. Cl. CPC H04W 74/0808; H04W 74/002

(57) ABSTRACT

Embodiments of the present disclosure relate to methods and apparatuses. According to some embodiments of the disclosure, a method may include: performing a channel access procedure based on a first channel access priority class (CAPC) value for initiating a channel occupancy time (COT) for transmitting data, wherein the first CAPC value is determined from a set of CAPC values based on a first priority level value of the data; and transmitting sidelink control information (SCI) within the COT, wherein the SCI indicates a subsequent time resource within the COT available for sidelink transmission

### TECHNICAL FIELD

Embodiments of the present disclosure generally relate to wireless communication technology, and more particularly to sharing channel occupancy time (COT).

### BACKGROUND

In a wireless communication system, a user equipment (UE), e.g. mobile device, may communicate with another UE via a data path supported by an operator's network, e.g. a cellular or a Wi-Fi network infrastructure. The data path supported by the operator's network may include a base station (BS) and multiple gateways.

In the case that UEs are relatively close to each other, a radio link or a sidelink can be established between both UEs to provide Device-to-Device (D2D) communication and without going through a direct link to the BS. The term “sidelink” or “SL” may refer to a direct radio link established for communicating among devices, e.g., UEs, as opposed to communicating via the cellular infrastructure (uplink and downlink) as discussed above. In this case, the “sidelink” is also referred to as a D2D or sidelink communication link. The sidelink communication link may be used in any suitable telecommunication network in accordance with various standards, where the telecommunication network may configure a resource pool to be used by UEs during such sidelink communication.

D2D communication has evolved into a vehicle-to-everything (V2X) communication in the Long Term Evolution (LTE) sidelink standard. The V2X communication technology encompasses communication involving vehicles as message sources or destinations. In a new radio (NR) communication system, a transmitting (Tx) UE may send a sidelink transmission to a specific receiving (Rx) UE in a unicast mode, to a group of Rx UEs in a groupcast mode, or to Rx UEs within a range in a broadcast mode.

A UE may operate in both licensed spectrum and unlicensed spectrum. For a transmission on unlicensed spectrum, in order to achieve fair coexistence with other wireless systems, the UE is required to perform a channel access procedure (e.g., a listen-before-talk (LBT) procedure) before the transmission on unlicensed spectrum. In the LBT procedure, the UE performs energy detection on a certain channel. If the detected energy is lower than a predefined threshold, the channel is deemed as empty and available for transmission, and then the LBT procedure is successful. Only when the LBT procedure is successful, the UE can start the transmission on the channel and occupy the channel a certain channel occupancy time (COT), which is less than a maximum channel occupancy time (MCOT). Otherwise, the UE cannot start the transmission and continue to perform another LBT procedure until a successful LBT procedure. Sidelink transmission may also be performed on unlicensed spectrum.

To improve the utilization of radio resource, there is a need for handling COT sharing between UEs for sidelink transmission on an unlicensed spectrum.

### SUMMARY

Some embodiments of the present disclosure provide a method. The method may include: performing a channel access procedure based on a first channel access priority class (CAPC) value for initiating a channel occupancy time (COT) for transmitting data, wherein the first CAPC value may be determined from a set of CAPC values based on a first priority level value of the data; and transmitting sidelink control information (SCI) within the COT, wherein the SCI may indicate a subsequent time resource within the COT available for sidelink transmission.

Some embodiments of the present disclosure provide a method. The method may be performed by a second user equipment (UE). The method may include receiving, from a first UE, first sidelink control information (SCI), wherein: the first SCI may indicate a subsequent time resource within a channel occupancy time (COT) available for sidelink transmission, the COT may be initiated by the first UE after performing a first channel access procedure for transmitting first data using a first channel access priority class (CAPC) value, and the first CAPC value may be determined from a set of CAPC values based on a first priority level value of the first data.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, to cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates a flow chart of an exemplary procedure of wireless communications in accordance with some embodiments of the present disclosure;

FIG. 3 illustrates a flow chart of an exemplary procedure of wireless communications in accordance with some embodiments of the present disclosure;

FIG. 4 illustrates an exemplary UE-initiated COT in accordance with some embodiments of the present disclosure;

FIG. 5 illustrates an exemplary UE-initiated COT in accordance with some embodiments of the present disclosure;

FIG. 6 illustrates an exemplary UE-initiated COT in accordance with some embodiments of the present disclosure;

FIG. 7 illustrates an exemplary UE-initiated COT in accordance with some embodiments of the present disclosure; and

FIG. 8 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

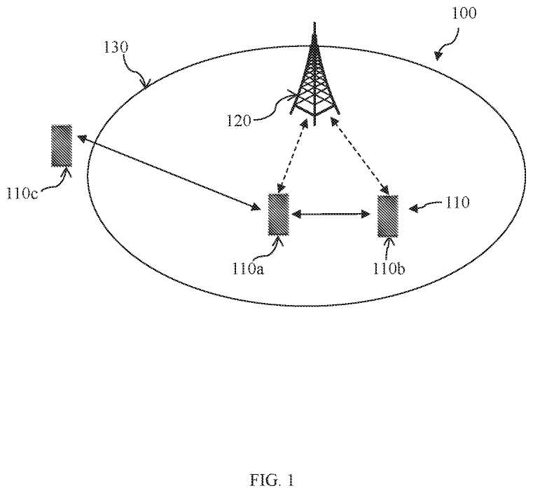

FIG. 1 illustrates a schematic diagram of a wireless communication system 100 in accordance with some embodiments of the present disclosure.

As shown in FIG. 1, a wireless communication system 100 may include a base station (e.g., BS 120) and some UEs 110 (e.g., UE 110a, UE 110b, and UE 110c). Although a specific number of UEs 110 and one BS 120 are depicted in FIG. 1, it is contemplated that wireless communication system 100 may also include more BSs and more or fewer UEs in and outside of the coverage of the BSs.

The UEs and the base station may support communication based on, for example, 3G, long-term evolution (LTE), LTE-advanced (LTE-A), new radio (NR), or other suitable protocol(s). In some embodiments of the present disclosure, the BS 102 may be referred to as an access point, an access terminal, a base, a base unit, a macro cell, a Node-B, an evolved Node B (eNB), a gNB, a Home Node-B, a relay node, or a device, or described using other terminology used in the art. The UE 110a, UE 110b, or UE 110c may include, for example, but is not limited to, a computing device, a wearable device, a mobile device, an IoT device, a vehicle, etc. Persons skilled in the art should understand that as technology develops and advances, the terminologies described in the present disclosure may change, but should not affect or limit the principles and spirit of the present disclosure.

The BS 120 may define one or more cells, and each cell may have a coverage area 130. In the exemplary wireless communication system 100, some UEs (e.g., UE 110a and UE 110b) are within the coverage of the BS 120, which may not be a specific base station 120 shown in FIG. 1 and can be any one of the base stations 120 in a wireless communication system, and some UEs (e.g., UE 110c) are outside of the coverage of the BS 120. For example, in the case that the wireless communication system includes two base stations 120 with UE 110a being within the coverage of any one of the two base stations 120 means that UE 110a is within the coverage of a base station 120 (i.e., in-coverage) in the wireless communication system; and UE 110a being outside of the coverage of both base stations 120 means that UE 110a is outside the coverage of a base station 120 (i.e., out-of-coverage) in the wireless communication system.

Still referring to FIG. 1, the UE 110a and UE 110b may communicate with the BS 120 via, for example, a Uu link (denoted by dotted arrow in FIG. 1). The UE 110a, UE 110b, and UE 110c may communicate with each other via a sidelink (denoted by solid arrow in FIG. 1), and may form a UE group. There may be two resource allocation modes for sidelink transmission. One of the two resource allocation modes is based on the scheduling of a base station, and may be referred to as mode 1; and the other is based on the autonomous selection of the UE, and may be referred to as mode 2.

In both mode 1 and mode 2, the sidelink transmission may involve physical sidelink control channel (PSCCH) and an associated physical sidelink shared channel (PSSCH), which is scheduled by the sidelink control information (SCI) carried on the PSCCH. The SCI and associated PSSCH may be transmitted from a transmitting UE (hereinafter referred to as “Tx UE”) to a receiving UE (hereinafter referred to as “Rx UE”) in a unicast manner, to a group of Rx UEs in a groupcast manner, or to Rx UEs within a range in a broadcast manner. For example, referring to FIG. 1, UE 110a (acting as a Tx UE) may transmit data to UE 110b or UE 110c (acting as an Rx UE).

In mode 1, resources may be assigned by a base station via dynamic scheduling or configured grant(s). In mode 2, a UE may need to perform resource sensing by monitoring and decoding all SCI transmitted in an SCI resource pool to obtain resource reservation information. By doing so, the UE may identify candidate resources that are available for communication. The UE may then, for example, randomly select required resources from the identified candidate resources.

BSs (e.g., BS 120 in FIG. 1) and UEs (e.g., UE 110a, UE 110b, and UE 110c in FIG. 1) may operate in both a licensed spectrum and an unlicensed spectrum. For example, the unlicensed spectrum may be at around 6 GHz or 60 GHz of a carrier frequency. NR-U (NR system access on unlicensed spectrum) operating bandwidth may be an integer multiple of 20 MHz. In order to achieve fair coexistence between NR systems (e.g., NR-U systems) and other wireless systems (e.g., Wi-Fi), a channel access procedure (e.g., a listen-before-talk (LBT) test or LBT procedure) may be performed in units of 20 MHz, before communicating on the unlicensed spectrum. For a carrier bandwidth larger than 20 MHz, e.g., 40 MHz, 60 MHz, 80 MHz, or 100 MHz, the carrier bandwidth may be partitioned into a plurality of subbands (also referred to as “LBT subbands”), each of which has a bandwidth of 20 MHz and may be indexed.

When unlicensed spectrum is used for sidelink transmission between UEs (e.g., between a Tx UE and an Rx UE(s)), a UE (e.g., a Tx UE) may be required to perform a channel access procedure (e.g., an LBT procedure) before performing any sidelink transmission. The LBT procedure may be performed based on energy detection in each sensing slot. In detail, if the detected energy on one channel in one sensing slot is lower than an energy detection threshold, then the channel is deemed as empty or clear or available in that sensing slot; otherwise, the channel is deemed as occupied or non-available in that sensing slot.

For a Type-1 channel access procedure, also named “LBT Category 4 or LBT Cat.4 procedure,” usually, the energy detection needs to be performed in a range from several sensing slots to hundreds of sensing slots. A random backoff counter is selected from a contention window at the beginning of the LBT Cat.4 procedure. The random backoff counter will be decremented by 1 each time when the UE detects that the channel is empty in one sensing slot. When the random backoff counter counts down to zero, the channel can be regarded as available and the LBT Cat.4 procedure is successful. Then, the UE can determine a COT not larger than an MCOT, and start the sidelink transmission on the channel within the COT. The above mentioned channel access parameters (e.g., contention window, backoff counter, and MCOT) are associated with a channel access priority class (CAPC) value determined based on the traffic data to be transmitted by the UE. The more detailed Type-1 channel access procedure is specified in 3GPP standard specification TS 37.213.

For example, 3GPP standard specification TS 37.213 shows a Table 4.1.1-1, which lists the CAPC for downlink (DL) transmission, i.e., the CAPC value used by a BS for performing an LBT Cat.4 procedure before DL transmission. 3GPP standard specification TS 37.213 also shows a Table 4.2.1-1, which lists the CAPC for uplink (UL) transmission, i.e., the CAPC value used by a UE for performing an LBT Cat.4 procedure before uplink transmission. Table 4.1.1-1 and Table 4.2.1-1 are reproduced below. The definitions of the parameters in the tables below are specified in 3GPP standard specification TS 37.213.

TABLE 4.1.1-1
Channel Access Priority Class for DL

| Channel | | | | | | |
|---|---|---|---|---|---|---|
| Access | | | | | | |
| Priority | | | | | | allowed |
| Class (p) | mₚ | CW_{min, p} | CW_{max, p} | T_{mcot, p} | | CWₚ sizes |
| 1 | 1 | 3 | 7 | 2 | ms | {3, 7} |
| 2 | 1 | 7 | 15 | 3 | ms | {7, 15} |
| 3 | 3 | 15 | 63 | 8 or 10 | ms | {15, 31, 63} |
| 4 | 7 | 15 | 1023 | 8 or 10 | ms | {15, 31, 63, |
| | | | | | | 127, 255, 511, |
| | | | | | | 1023} |

TABLE 4.2.1-1
Channel Access Priority Class for UL

| Channel | | | | | |
|---|---|---|---|---|---|
| Access | | | | | |
| Priority | | | | | allowed |
| Class (p) | mₚ | CW_{min, p} | CW_{max, p} | T_{ulmcot, p} | CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or 10 ms | {15, 31, 63, |
| | | | | | 127, 255, 511, |
| | | | | | 1023} |
| 4 | 7 | 15 | 1023 | 6 ms or 10 ms | {15, 31, 63, |
| | | | | | 127, 255, 511, |
| | | | | | 1023} |

NOTE 1:
For p = 3, 4, T_{ulmcot, p} = 10 ms if the higher layer parameter ‘absenceOfAnyOtherTechnology-r14’ indicates TRUE, otherwise, T_{ulmcot, p} = 6 ms.
NOTE 2:
When T_{ulmcot, p} = 6 ms it may be increased to 8 ms by inserting one or more gaps. The minimum duration of a gap shall be 100 μs. The maximum duration before including any such gap shall be 6 ms.

In some embodiments of the present disclosure, the above CAPC values defined for DL and UL transmissions may also be used for sidelink transmissions. For example, the data to be transmitted by a UE may be associated with a priority level. The UE may determine a CAPC value from the set of CAPC values for DL listed in Table 4.1.1-1 or the set of CAPC values for UL listed in Table 4.2.1-1 based on the priority level value of the data to be transmitted by the UE. However, under certain communication scenarios (e.g., a V2X communication scenario), more than 4 priority levels (e.g., 8 priority levels) are defined for sidelink data transmission while in the above tables, only 4 CAPC values are defined for each of DL and UL transmissions. Therefore, there is a need to redesign the CAPC values for sidelink transmissions.

Moreover, to improve the utilization of radio resource, there is a need for handling COT sharing between UEs for sidelink transmission on an unlicensed spectrum. More details on the embodiments of the present disclosure will be illustrated in the following text in combination with the appended drawings.

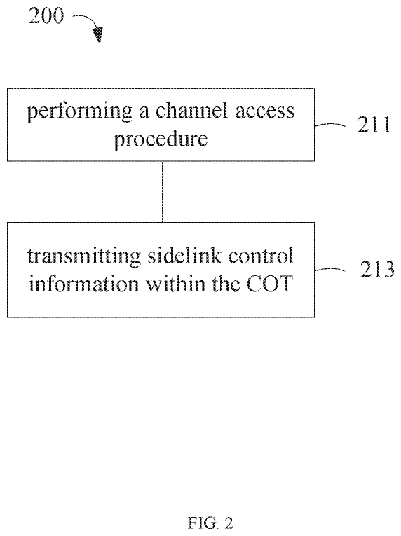

FIG. 2 illustrates a flow chart of an exemplary procedure 200 of wireless communications in accordance with some embodiments of the present disclosure. The procedure may be performed by a UE, for example, UE 110a, UE 110b, or UE 110c in FIG. 1.

Details described in all of the foregoing embodiments of the present disclosure are applicable for the embodiments shown in FIG. 2. It should be appreciated by persons skilled in the art that the sequence of the operations in exemplary procedure 200 may be changed and some of the operations in exemplary procedure 200 may be eliminated or modified, without departing from the spirit and scope of the disclosure.

In some embodiments of the present disclosure, a UE may determine a channel access priority class (CAPC) value from a set of CAPC values based on a priority level value of the data to be transmitted by the UE. Each CAPC value of the set of CAPC values may be associated with a set of channel access parameters (e.g., allowed contention window sizes, value of mₚ, and MCOT) and may correspond to a respective data priority level value. Referring to FIG. 2, in operation 211, the UE may perform a channel access procedure (e.g., Type-1 channel access procedure) based on the determined CAPC value for initiating a channel occupancy time (COT) for transmitting the data.

In some embodiments of the present disclosure, assuming that there are 8 data priority levels specified under a certain communication scenario, the set of CAPC values may be defined with 8 CAPC values, each of which corresponds to a respective one of the 8 data priority levels. For example, the 8 data priority levels may correspond to priority level values “0” to “7,” wherein priority level value “0” denotes the highest priority or priority level, and priority level value “7” denotes the lowest priority or priority level. The set of CAPC values may include CAPC values “1” to “8.” CAPC values “1” to “8” may correspond to priority level values “0” to “7,” respectively. It should be understood that the number of the data priority level, the priority level values, and the CAPC values here are only for illustrative purposes, and should not be construed as limits to the embodiments of the present disclosure.

The set of CAPC values and the associated channel access parameters may be defined based on at least one of the following principles:

the higher the priority level, the shorter the MCOT;

the higher the priority level, the smaller the mₚ value;

a shorter MCOT may be defined for more urgent traffic; and

whether or not there are other wireless system(s) sharing the same spectrum.

Tables 1-3 below show exemplary sets of CAPC values in consideration of some or all of the above principles.

TABLE 1
Channel Access Priority Class for sidelink transmission systems where
other wireless systems sharing the same spectrum do not exist

| CAPC (p) | mₚ | CW_{min, p} | CW_{max, p} | MCOTₚ | Allowed CWₚ sizes |
|---|---|---|---|---|---|
| 1 | 1 | 3 | 7 | 2 ms | {3, 7} |
| 2 | 2 | 3 | 7 | 2 ms | {3, 7} |
| 3 | 1 | 7 | 15 | 3 ms | {7, 15} |
| 4 | 2 | 7 | 15 | 4 ms | {7, 15} |
| 5 | 3 | 15 | 63 | 6 ms | {15, 31, 63} |
| 6 | 7 | 15 | 63 | 6 ms | {15, 31, 63} |
| 7 | 3 | 15 | 1023 | 8 ms | {15, 31, 63, 127, |
| | | | | | 255, 511, 1023} |
| 8 | 7 | 15 | 1023 | 10 ms | {15, 31, 63, 127, |
| | | | | | 255, 511, 1023} |

TABLE 2
Channel Access Priority Class for sidelink transmission systems
where other wireless systems sharing the same spectrum may exist

| CAPC (p) | mₚ | CW_{min, p} | CW_{max, p} | MCOTₚ | Allowed CWₚ sizes |
|---|---|---|---|---|---|
| 1 | 1 | 3 | 7 | 2 ms | {3, 7} |
| 2 | 2 | 3 | 7 | 2 ms | {3, 7} |
| 3 | 1 | 7 | 15 | 3 ms | {7, 15} |
| 4 | 2 | 7 | 15 | 4 ms | {7, 15} |
| 5 | 3 | 15 | 63 | 6 ms | {15, 31, 63} |
| 6 | 7 | 15 | 63 | 6 ms | {15, 31, 63} |
| 7 | 3 | 15 | 1023 | 8 ms | {15, 31, 63, 127, |
| | | | | | 255, 511, 1023} |
| 8 | 7 | 15 | 1023 | 8 ms | {15, 31, 63, 127, |
| | | | | | 255, 511, 1023} |

TABLE 3
Channel Access Priority Class for sidelink transmission systems
where other wireless systems sharing the same spectrum may exist

| CAPC (p) | mₚ | CW_{min, p} | CW_{max, p} | MCOTₚ | Allowed CWₚ sizes |
|---|---|---|---|---|---|
| 1 | 0 | 3 | 7 | 1 ms | {3, 7} |
| 2 | 1 | 3 | 7 | 2 ms | {3, 7} |
| 3 | 2 | 3 | 7 | 2 ms | {3, 7} |
| 4 | 1 | 7 | 15 | 3 ms | {7, 15} |
| 5 | 2 | 7 | 15 | 4 ms | {7, 15} |
| 6 | 3 | 15 | 63 | 6 ms | {15, 31, 63} |
| 7 | 3 | 15 | 1023 | 8 ms | {15, 31, 63, 127, |
| | | | | | 255, 511, 1023} |
| 8 | 7 | 15 | 1023 | 8 ms | {15, 31, 63, 127, |
| | | | | | 255, 511, 1023} |

Table 1 may be employed when it can be guaranteed that there are no other wireless systems (e.g., WiFi) on the unlicensed spectrum. Table 2 or Table 3 may be employed when other wireless systems (e.g., WiFi) may exist on the same unlicensed spectrum. In Table 3, a 1 ms MCOT (corresponding to CAPC value “1”) is introduced for a one-shot SCI/PSSCH transmission in the case of a very urgent traffic. It should be understood that the above Tables 1-3 are only for illustrative purposes, and should not be construed as limiting the embodiments of the present disclosure.

In some embodiments of the present disclosure, the 4 DL CAPC values defined in Table 4.1.1-1 of 3GPP standard specification TS 37.213 or 4 UL CAPC values defined in Table 4.2.1-1 of 3GPP standard specification TS 37.213 may be employed for sidelink transmissions. For example, at least one of the above-mentioned 4 DL CAPC values or 4 UL CAPC values may be reused to correspond to two or more priority levels.

Assuming that there are 8 data priority levels specified under a certain communication scenario, Tables 4A and 4B below show exemplary mappings between the CAPC values and the priority level values.

TABLE 4A
Mapping between priority level values and
CAPC values by reusing 4 DL CAPC values

| priority level | CAPC (p) |
|---|---|
| 0 | 1 |
| 1 | 1 |
| 2 | 2 |
| 3 | 2 |
| 4 | 3 |
| 5 | 3 |
| 6 | 4 |
| 7 | 4 |

TABLE 4B
Mapping between priority level values and
CAPC values by reusing 4 UL CAPC values

| priority level | CAPC (p) |
|---|---|
| 0 | 1 |
| 1 | 1 |
| 2 | 2 |
| 3 | 2 |
| 4 | 3 |
| 5 | 3 |
| 6 | 4 |
| 7 | 4 |

As shown in Table 4A, each of the 8 data priority levels (corresponding to priority level values “0” to “7”) are mapped to one of 4 DL CAPC values defined in Table 4.1.1-1 of 3GPP standard specification TS 37.213. As shown in Table 4B, each of the 8 data priority levels (corresponding to priority level values “0” to “7”) are mapped to one of 4 UL CAPC values defined in Table 4.2.1-1 of 3GPP standard specification TS 37.213. Some priority levels may correspond to the same CAPC value (e.g., the two highest priority levels having priority level values “0” and “1” correspond to CAPC value “1”), and thus may be associated with the same set of channel access parameters. It should be understood that the above Tables 4A and 4B are only for illustrative purposes, and should not be construed as limiting the embodiments of the present disclosure.

In some embodiments of the present disclosure, the set of CAPC values (e.g., Table 1 or Table 4A and Table 4.1.1-1) may be configured by a high layer (e.g., radio resource control (RRC)) signaling. In some embodiments of the present disclosure, the set of CAPC values may be predefined at a UE, e.g., predefined in standard.

In some embodiments of the present disclosure, the data to be transmitted by the UE may correspond to a plurality of priority level values, and may be transmitted in the same COT. Since each priority level value may correspond to a CAPC value, the data to be transmitted may correspond to a plurality of CAPC values. In some embodiments of the present disclosure, the UE may determine the CAPC value used for performing the channel access procedure based on the largest priority level value (i.e., the lowest priority) among the plurality of priority level values. In some embodiments of the present disclosure, the CAPC value used for performing the channel access procedure may be the largest CAPC value among the plurality of CAPC values.

Still referring to FIG. 2, after initiating a COT, the UE (hereinafter, “UE1”) may perform one or more contiguous sidelink transmissions without any gap in time domain. The UE may perform the sidelink transmission in a unicast mode, in a groupcast mode, or in a broadcast mode. For example, in operation 213, UE1 may transmit SCI (e.g., PSCCH) within the COT. UE1 may further transmit associated data (e.g., PSSCH) within the COT (not shown in FIG. 2). In some embodiments of the present disclosure, after its sidelink transmission, UE1 may determine to share a part or all of the remaining COT to at least one other UE for sidelink transmission. The at least one other UE may include the Rx UE(s) of the sidelink transmission of UE1 and any other UEs that monitor the SCI transmitted by UE1 in the SCI resource pool.

In some embodiments of the present disclosure, UE1 may disable hybrid automatic repeat request acknowledgement (HARQ-ACK) feedback for sidelink transmission. The HARQ-ACK feedback is carried on the physical sidelink feedback channel (PSFCH). In these embodiments, UE1 may not reserve a PSFCH resource in the COT, and thus can share the entire remaining COT to other UEs.

In some embodiments of the present disclosure, UE1 may enable the HARQ-ACK feedback for sidelink transmission in the COT. UE1 may reserve a PSFCH resource, for example, at the end of the COT. In these embodiments, UE1 can share the remaining COT excluding the reserved PSFCH resource to other UEs.

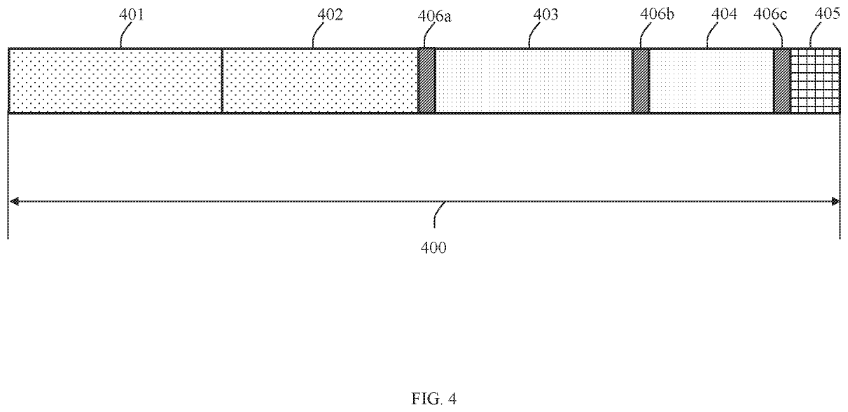

FIG. 4 illustrates an exemplary UE-initiated COT 400 with a PSFCH resource reserved at the end of the COT. UE1 may initiate the COT 400 for transmitting data after successfully performing a channel access procedure. As shown in FIG. 4, UE1 may perform sidelink transmission 401 and sidelink transmission 402 within the COT 400. Each of the sidelink transmission 401 and sidelink transmission 402 may include a corresponding SCI and the associated data scheduled by the SCI. UE1 may reserve resource for HARQ-ACK feedback corresponding to at least one of the sidelink transmission 401 and sidelink transmission 402 at the end of the COT 400. For example, UE1 may receive the PSFCH transmission 405 within the COT 400. UE1 may determine to share the remaining COT to other UEs. For example, a UE (named “UE2” for simplicity) may perform sidelink transmission 403 within the COT 400 using the shared resource, and another UE (named “UE3” for simplicity) may perform sidelink transmission 404 within the COT 400 using the shared resource.

Reference numerals 406a, 406b, and 406c represent gaps between different sidelink transmissions. A Type-2 channel access procedure, also named “LBT Category 2 or LBT Cat.2 procedure,” may be performed in some or all of the gaps. For example, before transmitting the sidelink transmission 403, UE2 may perform an LBT Cat.2 procedure in the gap 406a. The LBT Cat.2 procedure is different from the LBT Cat.4 procedure, and may require one-shot energy detection within a sensing interval of, for example, 16 us or at least 25 us. Due to one-shot sensing, the completion time of the LBT Cat.2 procedure is predictable. The LBT Cat.2 procedure may also be referred to as “one-shot LBT” hereinafter. The more detailed procedure for the Type-2 channel access procedure is specified in 3GPP standard specification TS 37.213.

In some embodiments of the present disclosure, the PSFCH transmission in a Tx UE-initiated COT may have the highest priority, e.g., the smallest CAPC value or the smallest priority level value. Hence, the PSFCH transmission may always be allowed in the Tx UE-initiated COT, regardless of the CAPC value or priority level value indicated in the SCI. For example, referring to FIG. 4, assuming that a UE (named “UE4” for simplicity) is the Rx UE of the sidelink transmission 401 from UE1, UE4 may transmit HARQ-ACK feedback corresponding to the sidelink transmission 401. The HARQ-ACK feedback may be carried on the PSFCH transmission 405, which is associated with the smallest CAPC value among a set of CAPC values or the smallest priority level value. The PSFCH transmission 405 may always be allowed to transmit in the COT 400 since it has the highest priority.

In some embodiments of the present disclosure, when the gap between the ending symbol of the last sidelink data transmission (e.g., PSSCH) in a Tx UE-initiated COT and the starting symbol of a PSFCH transmission is shorter than the shortest time for the one-shot LBT (e.g., 16 us), an Rx UE can directly transmit the PSFCH transmission without performing the one-shot LBT. For example, referring to FIG. 4, when the gap 406c in FIG. 4 is shorter than 16 us, UE4 may transmit PSFCH transmission 405 right after the sidelink transmission 404.

In some embodiments of the present disclosure, when the gap between the ending symbol of the last sidelink data transmission (e.g., PSSCH) in a Tx UE-initiated COT and the starting symbol of a PSFCH transmission is equal to the shortest time for the one-shot LBT (e.g., 16 us), an Rx UE can transmit the PSFCH transmission after a successful one-shot LBT with a 16 us sensing interval. For example, referring to FIG. 4, when the gap 406c in FIG. 4 is equal to 16 us, UE4 may perform a one-shot LBT with a 16 us sensing interval in gap 406c, and may transmit PSFCH transmission 405 after a successful one-shot LBT.

In some embodiments of the present disclosure, when the gap between the ending symbol of the last sidelink data transmission (e.g., PSSCH) in a Tx UE-initiated COT and the starting symbol of a PSFCH transmission is larger than the shortest time for the one-shot LBT (e.g., 16 us), an Rx UE can transmit the PSFCH transmission after a successful one-shot LBT with, for example, at least a 25 us sensing interval. For example, referring to FIG. 4, when the gap 406c in FIG. 4 is larger than 16 us, UE4 may perform a one-shot LBT with a 25 us sensing interval in gap 406c, and may transmit PSFCH transmission 405 after a successful one-shot LBT.

Referring back to FIG. 2, in some embodiments of the present disclosure, the CAPC value used for initiating the COT may be indicated in the SCI transmitted by UE1, so that other UEs (e.g., UE2) can determine whether they are allowed to use the shared resource or not. For example, UE2 may receive the SCI transmitted by UE1. UE2 may determine a CAPC value (hereinafter, “second CAPC value”) based on a priority level value (hereinafter, “second priority level value”) of the sidelink data to be transmitted by UE2. When the second CAPC value is smaller than or equal to the CAPC value used for initiating the COT (hereinafter, “first CAPC value”), UE2 may be allowed to transmit the sidelink data in the shared resource. Then, UE2 may perform sidelink transmission on the shared resource. The sidelink transmission may include at least one of a HARQ-ACK feedback transmission, a SCI transmission, and a PSSCH transmission, and may be destined for any UEs, including UE1 which initiates the COT. Otherwise, when the second CAPC value is larger than the first CAPC value, UE2 may not be allowed to transmit the sidelink data in the shared resource. Alternatively, upon reception of the first CAPC value in the SCI, UE2 may select the sidelink data with corresponding CAPC value smaller than or equal to the first CAPC value such that the selected sidelink data is allowed to be transmitted in the shared resource of the COT.

In some embodiments of the present disclosure, the priority level value corresponding to the CAPC value used for initiating the COT may be indicated in the SCI transmitted by UE1, so that other UEs (e.g., UE2) can determine whether they are allowed to use the shared resource or not. For example, UE2 may determine whether the second priority level value of the sidelink data to be transmitted by UE2 is smaller than or equal to the priority level value (hereinafter, “first priority level value”) on which the first CAPC value is based. UE2 may transmit the sidelink data in the shared resource when the second priority level value is smaller than or equal to the first priority level value. Otherwise, when the second priority level value is larger than the first priority level value, UE2 may not be allowed to transmit the sidelink data in the shared resource. Alternatively, upon reception of the first priority level value in the SCI, UE2 may select the sidelink data with corresponding priority level value smaller than or equal to the first priority level value such that the selected sidelink data is allowed to be transmitted in the shared resource of the COT.

In some embodiments of the present disclosure, the sidelink data to be transmitted by UE2 may correspond to a plurality of priority level values. Since each priority level value may correspond to a CAPC value, the sidelink data to be transmitted by UE2 may correspond to a plurality of CAPC values. In some embodiments of the present disclosure, the second priority level value may be the largest one among the plurality of priority level values. The second CAPC value may be the largest one among the plurality of CAPC values.

In some embodiments of the present disclosure, multiple UEs may determine that they are allowed to use the shared resource. Under certain circumstances, for example, when the multiple UEs perform the one-shot LBT procedure simultaneously to compete the shared resource, transmission collision may occur. To avoid such collision, more restrictions may be applied to the application scenario of COT sharing. For example, in some embodiments of the present disclosure, only the COT initiated for unicast transmission can be shared to other UEs. In some embodiments of the present disclosure, only the RX UE(s) of the sidelink transmission transmitted by UE1 is allowed to use the shared resource. For example, only the UE(s) with the destination identification (ID) included in the SCI transmitted by UE1 can use the shared resource. In some embodiments of the present disclosure, only the COT initiated for unicast transmission can be shared, and only the RX UE(s) of the sidelink transmission transmitted by UE1 is allowed to use the shared resource.

A UE which intends to share a COT initiated by the UE may need to indicate the shared resource within the COT to other UEs, so that other UEs can identify the shared resource. In some embodiments of the present disclosure, the shared resource within the COT may be indicated by a starting position of the shared resource and duration of the shared resource. In some examples, both the starting position and the duration of the shared resource may be indicated in SCI transmitted by the UE which initiates the COT. In some examples, one of the starting position and the duration of the shared resource may be indicated in SCI transmitted by the UE which initiates the COT, and the other may be configured by a high layer (e.g., radio resource control (RRC)) signaling. In some example, both the starting position and the duration of the shared resource may be configured by a high layer (e.g., RRC) signaling.

The starting position (denoted as X) of the shared resource may be in units of slots or in units of symbols. In some examples, the starting position may be indicated by a slot level offset between a slot where the SCI is transmitted and a slot where of the shared resource starts. In some examples, the starting position may be indicated by a symbol level offset between an ending symbol of a physical sidelink shared channel (PSSCH) transmission scheduled by the SCI and a starting symbol where the shared resource starts. The duration (denoted as Y) may be in units of slots or in units of symbols. In some examples, assuming that both X and Y are indicated in the units of slots, for SCI transmitted in slot n, it implies that the shared resource starts from slot n+X to slot n+X+Y−1, or from slot n+X+1 to slot n+X+Y.

The candidate values of X may include 0, 1, 2, 3, . . . , etc. The candidate values of Y may include 1, 2, 3, . . . , etc. The maximum value of X and the maximum value of Y may be dependent on the MCOT associated with the CAPC value and the subcarrier spacing (SCS) value of the carrier.

Table 5 below shows exemplary maximum numbers of slots in different MCOTs based on different SCSs. It should be understood that the below Table 5 is only for illustrative purposes, and should not be construed as limiting the embodiments of the present disclosure.

TABLE 5
Maximum number of slots in MCOT based on SCS

| | Max number | Max number | Max number | Max number |
|---|---|---|---|---|
| | of slots | of slots | of slots | of slots |
| | in MCOT | in MCOT | in MCOT | in MCOT |
| | based on | based on | based on | based on |
| MCOT | 15 kHz SCS | 30 kHz SCS | 60 kHz SCS | 120 kHz SCS |
| 1 ms | 1 | 2 | 4 | 8 |
| 2 ms | 2 | 4 | 8 | 16 |
| 3 ms | 3 | 6 | 12 | 24 |
| 4 ms | 4 | 8 | 16 | 32 |
| 6 ms | 6 | 12 | 24 | 48 |
| 8 ms | 8 | 16 | 32 | 64 |
| 10 ms | 10 | 20 | 40 | 80 |

Assuming that a UE operates on a carrier with the 15 kHz SCS and initiates a COT, which is equal to the MCOT of 10 ms, the maximum number of slots in the COT may be 10 slots according to the above Table 5. In some examples, assuming that both X and Y are indicated in the units of slots, since at least one slot (or a part of the slot) of the 10 slots in the COT may be used for sidelink transmission by the UE, the value of X may be in the range of 1 to 9 and the value of Y may be in the range of 1 to 9. The number of required bits required for indicating X or Y may be determined based on

$$⌈ {log}_{2} ( \frac{N ( N + 1 )}{2} ) ⌉ ,$$

where “┌ ┐” is the ceiling function, and N is the maximum value of X or Y. In the above examples (N=9), the number of bits required for indicating X or Y may be 6 bits.

From the perspective of a UE which initiates and shares a COT, as a principle, the resource used by the UE and the duration of the shared resource should not exceed the MCOT determined based on the corresponding CAPC value. In some embodiments of the present disclosure, to reduce signaling overhead, the value of X and the value of Y may be limited to two respective sets, rather than being any values that satisfy the above principle. In some examples, a set of candidate values of X may be configured by a high layer (e.g., RRC) signaling or be predefined at a UE. The UE may select the value of X from the set of candidate values of X. Similarly, a set of candidate values of Y may be configured by a high layer (e.g., RRC) signaling or be predefined at a UE. The UE may select the value of Y from the set of candidate values of Y.

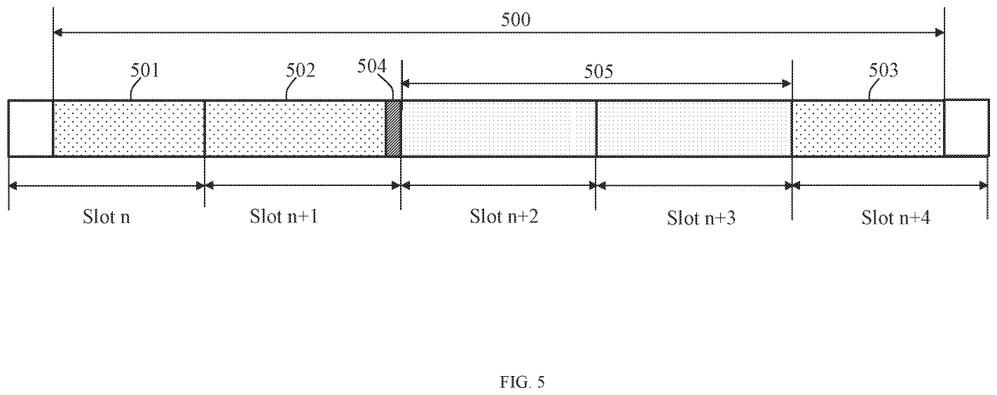

FIG. 5 illustrates an exemplary UE-initiated COT 500 in accordance with some embodiments of the present disclosure. In the example of FIG. 5, it is assumed that the shared resource within the COT 500 is indicated in the units of slots. That is, both the starting position (X) and duration (Y) of the shared resource are indicated in the units of slots. Details described in all of the foregoing embodiments of the present disclosure are applicable for the embodiments shown in FIG. 5.

A UE (UE1) may initiate the COT 500 for transmitting data after successfully performing a channel access procedure. The COT 500 may start at slot n and end at slot n+4. As shown in FIG. 5, the last slot (slot n+4) in the COT 500 is not fully included in the COT 500. In some other embodiments of the present disclosure, the last slot in the COT 500 may be fully included in the COT 500.

UE1 may transmit sidelink transmission 501 and sidelink transmission 502 within the COT 500. Each of the sidelink transmission 501 and sidelink transmission 502 may include a corresponding SCI and the associated data scheduled by the SCI. Reference numeral 504 represents a gap in which a Type-2 channel access procedure may be performed.

UE1 may determine to share a subsequent time resource within the COT 500 to other UEs for sidelink transmission. Since in the example of FIG. 5 it is assumed that the value of Y is indicated in units of slots, and the last slot (slot n+4) in the COT 500 is not fully included in the COT 500, resource 503 in slot n+4 within the COT 500 cannot be shared to other UEs. For example, UE1 may determine to share resource 505 from slot n+2 to slot n+3 to other UEs. The resource 503 may be used by UE1 for additional sidelink transmission (e.g., SCI and associated PSSCH transmission), or may be used by Rx UE(s) for PSFCH transmission, or may be abandoned by UE 1.

In some embodiments of the present disclosure, both the value of X and the value of Y may be indicated in the SCI transmitted by a UE. The value of X and the value of Y may be jointly or separated indicated in the SCI. For example, the value of X and the value of Y may be indicated in one field (e.g., via resource indication value (RIV)) or two separate fields in the SCI. In these embodiments, the value of X may be updated slot by slot by the UE in different SCI indicating the same shared resource. Although different values of X may be indicated in several consecutive SCI indicating the same shared resource, they may direct to the same starting position of the shared resource. On the other hand, the values of Y in the several consecutive SCI are the same. For example, referring to FIG. 5, the SCI (hereinafter, “SCI1”) transmitted in the sidelink transmission 501 (slot n) may indicate X=2 and Y=2, which implies that the shared resource locates at slot n+2 to n+3. The SCI (hereinafter, “SCI2”) transmitted in the sidelink transmission 502 (slot n+1) may indicate X=1 and Y=2, which also implies that the shared resource locates at slot n+2 to n+3.

In some embodiments of the present disclosure, the field for joint indication of X and Y, or the field only for indication of Y may be set as invalid in SCI. In some examples, the value of Y may be set as a non-numerical value or 0. This may indicate that slot n+X is not to be shared. In some embodiments of the present disclosure, X may be set as invalid in SCI. In some examples, the value of X may be set as a non-numerical value or 0. This may indicate that slot n+X is not to be shared. The non-numerical value may be of an enumerated type. For example, the value of X or Y may be enumerated as {invalid, 1, 2, . . . }, {inapplicable, 1, 2, . . . }, or {invalid/inapplicable, 1, 2, . . . }.

In some embodiments of the present disclosure, the value of X may be configured by a high layer (e.g., RRC) signaling, and the value of Y may be indicated in the SCI transmitted by a UE. When the UE transmits SCI in slot n, and determines not to share slot n+X. The UE may set the value of Y as invalid in the SCI, so as to indicate that slot n+X is not to be shared. For example, the value of Y may be set as a non-numerical value or 0. When the UE transmits SCI in slot n, and determines to share slot n+X to slot n+X+Y−1, the UE may set the value of Y as a valid value (e.g., 2) in the SCI, so as to indicate that slot n+X to slot n+X+Y−1 is to be shared. In some cases, the UE may transmit multiple SCI, the value of X may refer to an offset between a slot where a certain SCI (e.g., the first SCI) among the multiple SCI is transmitted and a slot where of the shared resource starts.

In some embodiments of the present disclosure, the value of Y may be configured by a high layer (e.g., RRC) signaling, and the value of X may be indicated in the SCI transmitted by a UE. The value of X may be updated slot by slot by the UE in different SCI indicating the same shared resource. In some embodiments of the present disclosure, X may be set as invalid in SCI. In some examples, the value of X may be set as a non-numerical value or 0. This may indicate that the UE determines not to share the COT.

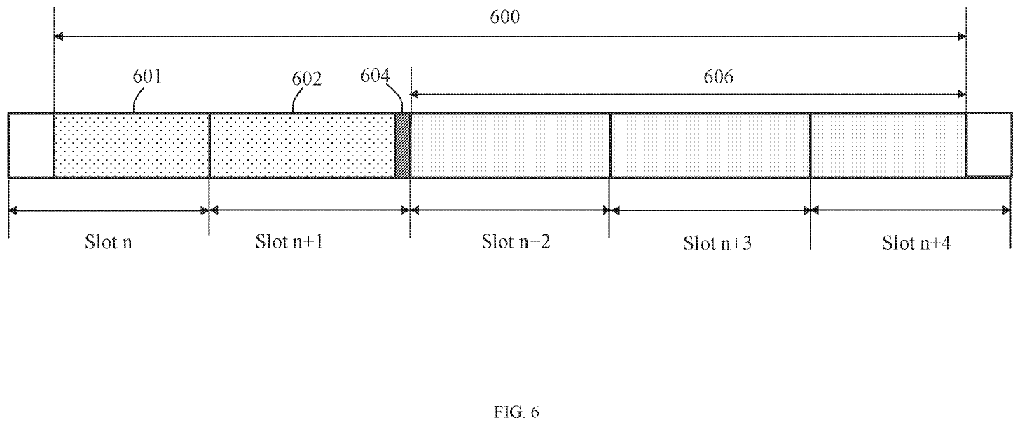

FIG. 6 illustrates an exemplary UE-initiated COT 600 in accordance with some embodiments of the present disclosure. In the example of FIG. 6, it is assumed that the starting position (X) of the shared resource within the COT 600 is indicated in the units of slots, and the duration (Y) of the shared resource within the COT 600 is indicated in the units of symbols. Details described in all of the foregoing embodiments of the present disclosure are applicable for the embodiments shown in FIG. 6.

The example shown in FIG. 6 may further improve channel resource usage, which will be explained in the following text.

A UE (UE1) may initiate the COT 600 for transmitting data after successfully performing a channel access procedure. The COT 600 may start at slot n and end at slot n+4. As shown in FIG. 6, the last slot (slot n+4) in the COT 600 is not fully included in the COT 600. In some other embodiments of the present disclosure, the last slot in the COT 600 may be fully included in the COT 600.

UE1 may transmit sidelink transmission 601 and sidelink transmission 602 within the COT 600. Each of the sidelink transmission 601 and sidelink transmission 602 may include a corresponding SCI and the associated data scheduled by the SCI. Reference numeral 604 represents a gap in which a Type-2 channel access procedure may be performed.

UE1 may determine to share a subsequent time resource within the COT 600 to other UEs for sidelink transmission. Since in the example of FIG. 6, it is assumed that the value of Y is indicated in the unit of symbols, although the last slot (slot n+4) in the COT 600 is not fully included in the COT 600, the resource in slot n+4 within the COT 600 can be shared to other UEs. For example, UE1 may determine to share resource 606 which occupies slot n+2, slot n+3, and a part of slot n+4 to other UEs.

In some embodiments of the present disclosure, a set of candidate values of Y in the unit of symbols may be configured by a high layer (e.g., RRC) signaling or be predefined. The value of Y in the unit of symbols may be configured by a high layer (e.g., RRC) signaling and/or dynamically indicated in the SCI transmitted from UE.

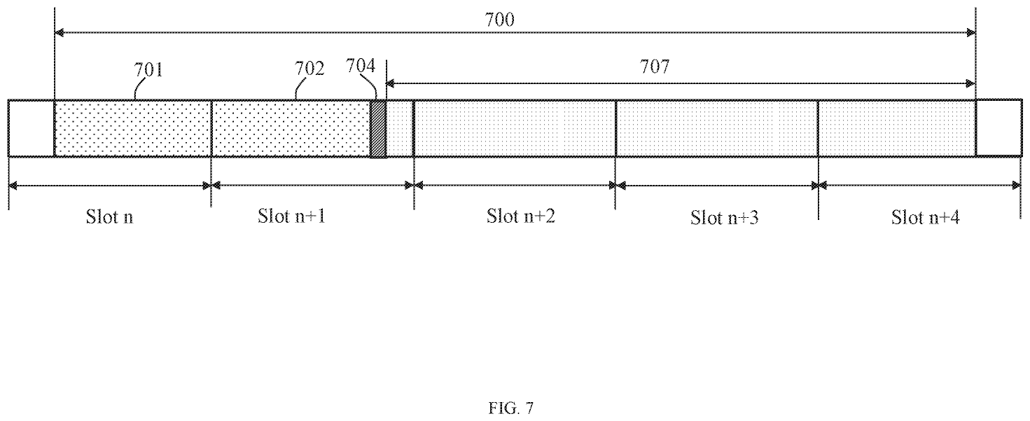

FIG. 7 illustrates an exemplary UE-initiated COT 700 in accordance with some embodiments of the present disclosure. In the example of FIG. 7, it is assumed that both the starting position (X) and the duration (Y) of the shared resource within the COT 700 are indicated in the units of symbols. In other words, the starting position of the shared resource may be determined based on a symbol level offset between the ending symbol of the PSSCH scheduled by the SCI and the starting symbol of the shared resource.

The example shown in FIG. 7 may further improve channel resource usage, which will be explained in the following text. Details described in all of the foregoing embodiments of the present disclosure are applicable for the embodiments shown in FIG. 7.

A UE (UE1) may initiate the COT 700 for transmitting data after successfully performing a channel access procedure. The COT 700 may start at slot n and end at slot n+4. As shown in FIG. 7, the last slot (slot n+4) in the COT 700 is not fully included in the COT 700. In some other embodiments of the present disclosure, the last slot in the COT 700 may be fully included in the COT 700.

UE1 may transmit sidelink transmission 701 and sidelink transmission 702 within the COT 700. Each of the sidelink transmission 701 and sidelink transmission 702 may include a corresponding SCI and the associated data scheduled by the SCI. Reference numeral 704 represents a gap in which a Type-2 channel access procedure may be performed.

UE1 may determine to share a subsequent time resource within the COT 700 to other UEs for sidelink transmission. Since in the example of FIG. 7, it is assumed that the value of X and the value of Y are indicated in the unit of symbols, the starting position of the share resource is not necessary to be the beginning of a slot, and the resource in slot n+4 within the COT 700 can be shared to other UEs. For example, UE1 may determine to share resource 707 which occupies a part of slot n+1, slot n+2, slot n+3, and a part of slot n+4 to other UEs. Therefore, in the example of FIG. 7 in which the symbol level unit is employed, even if there are one or more symbols unused by UE1 due to, for example, completion of sidelink transmission of UE1 earlier than the last symbol (e.g., symbol 13) within a slot, the remaining symbol within the slot can be shared to other UEs.

In some embodiments of the present disclosure, a set of candidate values of X in the unit of symbols may be configured by a high layer (e.g., RRC) signaling or be predefined. The value of X in the unit of symbols may be configured by a high layer (e.g., RRC) signaling and/or dynamically indicated in the SCI transmitted from UE.

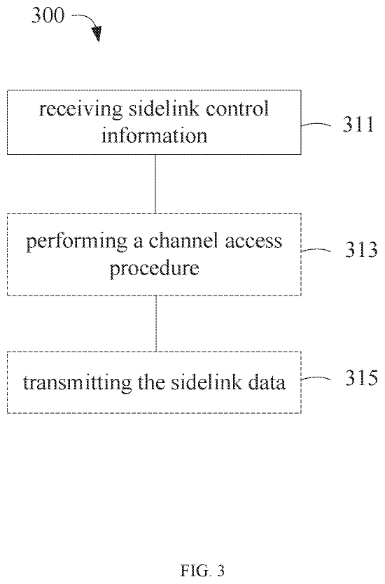

FIG. 3 illustrates a flow chart of an exemplary procedure 300 of wireless communication according to some embodiments of the present disclosure. Details described in all of the foregoing embodiments of the present disclosure are applicable for the embodiments shown in FIG. 3. The procedure may be performed by a UE, for example, UE 110a, UE 110b, or UE 110c in FIG. 1.

At the beginning, a UE (UE1) may initiate a COT after performing a channel access procedure (e.g., Type-1 channel access procedure) for transmitting data using a CAPC value, according to one of the methods described above with respect to FIG. 2. For example, the CAPC value (CAPC #1) may be determined from a set of CAPC values based on a priority level value (priority level value #1) of the data. UE1 may then perform sidelink transmission to transmit SCI and associated data within the COT. The SCI may include information related to the COT, for example, information indicating shared resource within the COT initiated by UE1. The SCI may be determined according to one of the methods described above with respect to FIGS. 2 and 4-7.

Referring to FIG. 3, in operation 311, another UE (UE2) may receive the SCI transmitted from UE1. UE2 can be the Rx UE(s) of the sidelink transmission of UE1 and any other UEs that monitors the SCI transmitted by UE1 in the SCI resource pool. UE2 may identify the shared resource within the COT initiated by UE1 based on the SCI. UE2 may determine a CAPC value (CAPC #2) associated with sidelink data to be transmitted, according to one of the methods described above with respect to FIG. 2. For example, CAPC #2 may be determined from a set of CAPC values based on a priority level value (priority level value #2) of the sidelink data to be transmitted.

In some embodiments of the present disclosure, the SCI may indicate CAPC #1. UE2 may compare CAPC #2 with CAPC #1. When CAPC #2 is smaller than or equal to CAPC #1, UE2 may, in operation 313 (denoted by dotted block as an option), perform a channel access procedure (e.g., a Type-2 channel access procedure). When the channel access procedure is successful, UE2 may, in operation 315 (denoted by dotted block as an option), transmit the sidelink data in the shared resource within the COT. UE2 may also transmit SCI in the shared resource within the COT. The SCI transmitted by UE2 may schedule a PSSCH, which carries the sidelink data.

In some embodiments of the present disclosure, the SCI may indicate priority level value #1. UE2 may compare priority level value #2 with priority level value #1. When priority level value #2 is smaller than or equal to priority level value #1, UE2 may, in operation 313 (denoted by dotted block as an option), perform a channel access procedure (e.g., a Type-2 channel access procedure). When the channel access procedure is successful, UE2 may, in operation 315 (denoted by dotted block as an option), transmit the sidelink data in the shared resource within the COT. UE2 may also transmit SCI in the shared resource within the COT. The SCI transmitted by UE2 may schedule a PSSCH, which carries the sidelink data.

In some embodiments of the present disclosure, UE2 can be any UEs that monitor the SCI transmitted by UE1 in the SCI resource pool. The SCI and the associated sidelink data transmitted by UE2 may be destined for any UEs, including UE1 which initiate the COT. UE2 may also transmit the HARQ-ACK feedback in the shared resource within the COT initiated by UE1.

In some embodiments of the present disclosure, UE2 is an Rx UE of the sidelink transmission of UE1. For example, the SCI transmitted by UE1 may indicate the destination identification (ID) of UE2. The sidelink data transmitted by UE2 in the shared resource within the COT may include HARQ-ACK feedback corresponding to the sidelink transmission transmitted by UE1. The HARQ-ACK feedback may be associated with the smallest CAPC value among the set of CAPC values or the smallest priority level value.

In some embodiments of the present disclosure, UE2 may receive RRC signaling from a BS or a Tx UE (e.g., UE1). In some embodiments of the present disclosure, the RRC signaling may indicate a set of CAPC values, a set of candidate values of the starting position of the shared resource within a COT, a set of candidate values of the duration of the shared resource, or any combination thereof. In some embodiments of the present disclosure, the RRC signaling may indicate the starting position of the shared resource within a COT or the duration of the shared resource within the COT. In some embodiments of the present disclosure, UE2 may identify the shared resource within a COT based on the RRC signaling and SCI.

It should be appreciated by persons skilled in the art that the sequence of the operations in exemplary procedure 300 may be changed and some of the operations in exemplary procedure 300 may be eliminated or modified, without departing from the spirit and scope of the disclosure.

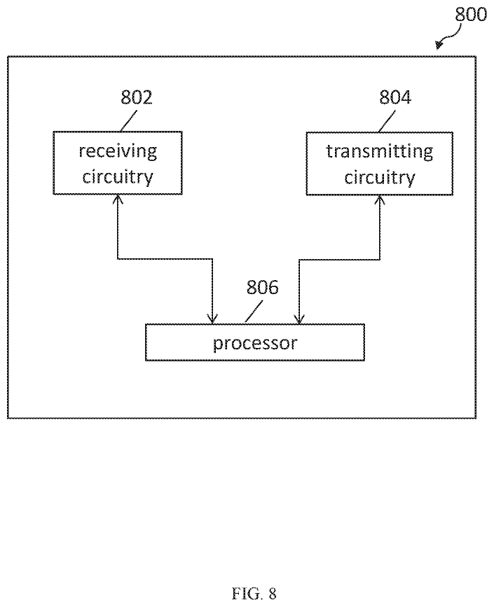

FIG. 8 illustrates an example block diagram of an apparatus 800 according to some embodiments of the present disclosure.

As shown in FIG. 8, the apparatus 800 may include at least one non-transitory computer-readable medium (not illustrated in FIG. 8), a receiving circuitry 802, a transmitting circuitry 804, and a processor 806 coupled to the non-transitory computer-readable medium (not illustrated in FIG. 8), the receiving circuitry 802 and the transmitting circuitry 804. The apparatus 800 may be a BS or a UE.

Although in this figure, elements such as processor 806, transmitting circuitry 804, and receiving circuitry 802 are described in the singular, the plural is contemplated unless limitation to the singular is explicitly stated. In some embodiments of the present disclosure, the receiving circuitry 802 and the transmitting circuitry 804 are combined into a single device, such as a transceiver. In certain embodiments of the present disclosure, the apparatus 800 may further include an input device, a memory, and/or other components.

In some embodiments of the present disclosure, the non-transitory computer-readable medium may have stored thereon computer-executable instructions to cause a processor to implement the operations with respect to the UE as described above. For example, the computer-executable instructions, when executed, cause the processor 806 interacting with receiving circuitry 802 and transmitting circuitry 804, so as to perform the steps with respect to the UE depicted in FIGS. 1-7.

In some examples, the processor 806 may perform a channel access procedure based on a CAPC value for initiating a COT for transmitting data. The CAPC value may be determined from a set of CAPC values based on a priority level value of the data. The transmitting circuitry 804 may transmit SCI within the COT. The SCI may indicate a subsequent time resource within the COT available for sidelink transmission.

In some examples, the receiving circuitry 802 may receive SCI, which may indicate a subsequent time resource within a COT available for sidelink transmission. The COT may be initiated by a UE after the UE performs a channel access procedure for transmitting data using a CAPC value. The CAPC value may be determined from a set of CAPC values based on a priority level value of the data to be transmitted by the UE.

In some embodiments of the present disclosure, the non-transitory computer-readable medium may have stored thereon computer-executable instructions to cause a processor to implement the method with respect to the BS as described above. For example, the computer-executable instructions, when executed, cause the processor 806 interacting with receiving circuitry 802 and transmitting circuitry 804, so as to perform the steps with respect to the BS depicted in FIGS. 1-7. For example, the transmitting circuitry 804 may transmit a set of CAPC values, a set of candidate values of the starting position of the shared resource, a set of candidate values of the duration of the shared resource, or any combination thereof to a UE. The transmitting circuitry 804 may transmit the starting position of the shared resource within a COT or the duration of the shared resource within the COT to a UE.

Those having ordinary skill in the art would understand that the steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes”, “including”, or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a”, “an”, or the like does not, without more constraints, preclude the existence of additional identical elements in the process, method, article, or apparatus that includes the element. Also, the term “another” is defined as at least a second or more. The term “having” and the like, as used herein, are defined as “including”.

1. A method, comprising:
performing a channel access procedure based on a first channel access priority class (CAPC) value for initiating a channel occupancy time (COT) for transmitting data, wherein the first CAPC value is determined from a set of CAPC values based on a first priority level value of the data; and
transmitting sidelink control information (SCI) within the COT, wherein the SCI indicates subsequent time resource within the COT available for sidelink transmission.

2. The method of claim 1, further comprising:
receiving the sidelink transmission in the subsequent time resource, wherein the sidelink transmission comprises at least one of a hybrid automatic repeat request acknowledgement (HARQ-ACK) feedback transmission, a SCI transmission, and a physical sidelink shared channel (PSSCH) transmission.

3. The method of claim 1, wherein each CAPC value of the set of CAPC values is associated with a set of channel access parameters, and corresponds to a respective data priority level value.

4-35. (canceled)

36. An apparatus, comprising:
a receiving circuitry;
a transmitting circuitry; and
a processor coupled to the receiving circuitry and the transmitting circuitry configured to cause the apparatus to:
perform a channel access procedure based on a first channel access priority class (CAPC) value for initiating a channel occupancy time (COT) for transmitting data, wherein the first CAPC value is determined from a set of CAPC values based on a first priority level value of the data; and
transmit sidelink control information (SCI) within the COT, wherein the SCI indicates subsequent time resource within the COT available for sidelink transmission.

37. An apparatus, comprising:
a receiving circuitry;
a transmitting circuitry; and
a processor coupled to the receiving circuitry and the transmitting circuitry configured to cause the apparatus to:
receive, from a first user equipment (UE), first sidelink control information (SCI), wherein:
the first SCI indicates subsequent time resource within a channel occupancy time (COT) available for sidelink transmission,
the COT is initiated by the first UE after performing a first channel access procedure for transmitting first data using a first channel access priority class (CAPC) value, and
the first CAPC value is determined from a set of CAPC values based on a first priority level value of the first data.

38. The apparatus of claim 37, wherein the first SCI further indicates the first CAPC value, and the processor, receiving circuitry, and transmitting circuitry are further comprising to cause the apparatus to:
compare a second CAPC value associated with sidelink data to be transmitted by the apparatus with the first CAPC value;
perform a second channel access procedure when the second CAPC value is smaller than or equal to the first CAPC value; and
transmit the sidelink data in the subsequent time resource when the second channel access procedure is successful.

39. The apparatus of claim 37, wherein the first SCI further indicates the first priority level value, and the processor, receiving circuitry, and transmitting circuitry are further comprising to cause the apparatus to:
compare a second priority level value of sidelink data to be transmitted by the apparatus with the first priority level value;
perform a second channel access procedure when the second priority level value is smaller than or equal to the first priority level value; and
transmit the sidelink data in the subsequent time resource when the second channel access procedure is successful.

40. The apparatus of claim 36, wherein at least one CAPC value of the set of CAPC values corresponds to two or more data priority level values.

41. The apparatus of claim 36, wherein the set of CAPC values is configured by a radio resource control (RRC) signaling or is predefined.

42. The apparatus of claim 36, wherein the data corresponds to a plurality of priority level values, and the first priority level value is a largest one among the plurality of priority level values.

43. The apparatus of claim 36, wherein the data corresponds to a plurality of CAPC values, and the first CAPC value is a largest one among the plurality of CAPC values.

44. The apparatus of claim 36, wherein the SCI indicates the first CAPC value or the first priority level value.

45. The apparatus of claim 36, wherein the COT is initiated for unicast transmission.

46. The apparatus of claim 36, wherein the SCI indicates a starting position of the subsequent time resource and duration of the subsequent time resource.

47. The apparatus of claim 36, wherein the SCI indicates duration of the subsequent time resource, and a starting position of the subsequent time resource is configured by a radio resource control (RRC) signaling.

48. The apparatus of claim 36, wherein the SCI indicates a starting position of the subsequent time resource, and duration of the subsequent time resource is configured by a radio resource control (RRC) signaling.

49. The apparatus of claim 48, wherein the starting position of the subsequent time resource is indicated by:
a slot level offset of the subsequent time resource between a slot where the SCI is transmitted and a slot where the subsequent resource starts; or
a symbol level offset of the subsequent time resource between an ending symbol of a physical sidelink shared channel (PSSCH) transmission scheduled by the SCI and a starting symbol where the subsequent resource starts.

50. The apparatus of claim 49, wherein the slot level offset or the symbol level offset is from a set of level offset values, and the set of level offset values is configured by a radio resource control (RRC) signaling or is predefined.

51. The apparatus of claim 48, wherein the duration of the subsequent time resource is in units of slots or in units of slots symbols.

52. The apparatus of claim 51, wherein the duration of the subsequent time resource is from a set of duration values, and the set of duration values is configured by a radio resource control (RRC) signaling or is predefined.
